(19) United States
(12) Patent Application Publication
(10) Pub. No.: US 2025/0011666 A1
(43) Pub. Date: Jan. 9, 2025

(54) PROCESS FOR EFFICIENT RECOVERY OF PRODUCTS FROM FCC & STEAM CRACKER COMBINED EFFLUENT

(71) Applicant: LUMMUS TECHNOLOGY LLC, Houston, TX (US)

(72) Inventors: Rakesh Kumar Mishra, Houston, TX (US); Sumit Mittal, Houston, TX (US); Vishal Varshney, Houston, TX (US); Ian Belwood, Houston, TX (US); Ankur Jain, Houston, TX (US); Srikanta Kumar Ghosh, Houston, TX (US); Amit Kumar Agrawal, Houston, TX (US); Abhik Banerjee, Houston, TX (US); Mangesh M. Gundale, Houston, TX (US)

(73) Assignee: LUMMUS TECHNOLOGY LLC, Houston, TX (US)

(21) Appl. No.: 18/763,888

(22) Filed: Jul. 3, 2024

(30) Foreign Application Priority Data
Jul. 4, 2023 (IN) 202321044815

(51) Int. Cl. C10G 69/06; B01D 3/14; B01D 3/34; B01J 8/18; B01J 8/24; B01J 19/24

(52) U.S. Cl. CPC C10G 69/06; B01D 3/143; B01D 3/346; B01J 8/1827; B01J 8/24; B01J 19/245; C10G 2400/20; C10G 2400/30

(57) ABSTRACT

Embodiments herein relate to solutions to maximize the recovery of ethylene, propylene and aromatics rich naphtha from crude oil processing. The schemes involve treating the effluent from Fluid Catalytic Cracking (FCC) to remove metals like AsH₃, PH₃, Hg, as well as impurities such as NOx and oxygen, before mixing it with the steam cracker effluent. The combined effluent is then cooled in a cold box and sent to various fractionators for separating the ethylene, propylene, and aromatics rich naphtha.

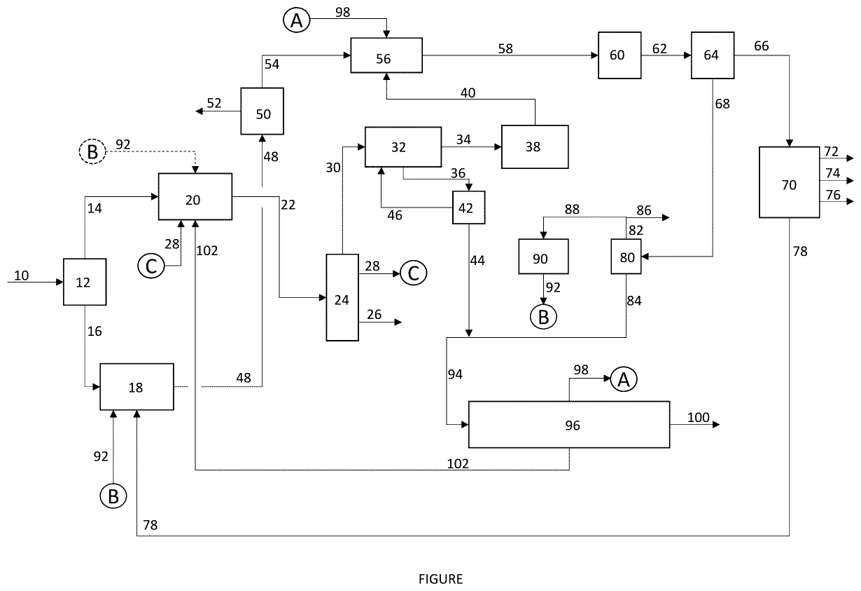

### FIELD OF THE DISCLOSURE

Embodiments of the present disclosure generally relate to the recovery of petrochemical building blocks such as ethylene, propylene and aromatics rich naphtha from direct crude processing.

### BACKGROUND

In recent years, the changing dynamics of the market have prompted refineries to explore new opportunities in petrochemical production from crude oil, shifting their focus beyond fuel production as fuel demand is depleting. Among the key building blocks for the petrochemical industry, ethylene and propylene hold significant importance. Due to the depleting demand of the fuels and increasing demand of the petrochemicals, refiners are being compelled to find the options to maximize petrochemicals from processing a variety of crude oils. Ethylene and propylene are expected to be in high demand, as they are the primary feed stock for the petrochemical/polymer industries.

Various processes have been proposed that integrate catalytic cracking and steam pyrolysis, such as U.S. Pat. No. 7,128,827, among others. However, mixing of catalytic cracking and steam cracker effluents poses a risk in cold box operations, as NOₓ depositions may occur in cold box operations typically used for recovery of ethylene.

### SUMMARY OF THE CLAIMED EMBODIMENTS

In one aspect, embodiments disclosed herein relate to a process for producing olefins and aromatics from wide boiling hydrocarbon feedstock. The process includes separating the wide boiling hydrocarbon feedstock into a light fraction and a heavy fraction.

The heavy fraction is catalytically cracked to produce a catalytically cracked effluent, which is fractionating to recover at least a wet gas fraction, a naphtha range fraction, and a heavy catalytically cracked fraction. The process further includes compressing and separating the wet gas fraction to form a light compressed fraction and a heavy compressed fraction. Impurities are removed from the light compressed fraction to form a purified light compressed fraction. The heavy compressed fraction is stripped to recover a stripped heavy fraction and a stripper gas fraction. The stripper gas fraction is combined with the wet gas fraction prior to the compressing and separating step.

The light fraction is thermally cracked to produce a thermally cracked effluent, which is quenched and separated to recover a fuel oil fraction and a light thermally cracked fraction. The light thermally cracked fraction is combined with the purified light compressed fraction to form a combined catalytic and thermally cracked light fraction, which is dried to form a dried lights fraction, which is then separated to recover a C4+ hydrocarbon fraction and a C3− hydrocarbon fraction. The C4+ fraction is split into one or more C5− fractions and a C6+ fraction. The C6+ fraction is mixed with the stripped heavy fraction to form a combined C6+ fraction, which is partially or fully hydrogenated to form a hydrogenated C6+ fraction. The hydrogenated C6+ fraction is separated to recover an offgas fraction, an aromatics rich naphtha fraction, and a raffinate fraction. The C3− fraction is separated to recover a hydrogen-containing offgas fraction, an ethylene fraction, a propylene fraction, and a light paraffin fraction.

In another aspect, embodiments disclosed herein relate to a system for producing olefins and aromatics from a wide boiling hydrocarbon feedstock. The system includes a separation system for separating the wide boiling hydrocarbon feedstock into a light fraction and a heavy fraction, and a fluid catalytic cracking unit for catalytically cracking the heavy fraction to produce a catalytically cracked effluent. A fractionation system is provided for fractionating the catalytically cracked effluent to recover at least a wet gas fraction, a naphtha range fraction, and a heavy catalytically cracked fraction. A wet gas compression system compresses and separates the wet gas fraction to form a light compressed fraction and a heavy compressed fraction. An impurities removal system is provided for removing impurities from the light compressed fraction to form a purified light compressed fraction. The system also includes a stripper for stripping the heavy compressed fraction to recover a stripped heavy fraction and a stripper gas fraction. A flow line is provided for combining the stripper gas fraction with the wet gas fraction upstream of the wet gas compression system. The system also includes a steam cracker system for thermally cracking the light fraction to produce a thermally cracked effluent, as well as a quench and separation system for quenching and separating the thermally cracked effluent to recover a fuel oil fraction and a light thermally cracked fraction. A mixer is provided for combining the light thermally cracked fraction with the purified light compressed fraction to form a combined catalytic and thermally cracked light fraction. The system further includes a compression and drying system for drying the combined catalytic and thermally cracked light fraction to form a dried lights fraction, and a lights separation system for separating the dried lights fraction to recover a C4+ hydrocarbon fraction and a C3− hydrocarbon fraction. A splitter is provided for splitting the C4+ fraction into one or more C5− fractions and a C6+ fraction. A mixer is provided for mixing the C6+ fraction with the stripped heavy fraction to form a combined C6+ fraction. The system also includes a hydrogenation system for partially hydrogenating the combined C6+ fraction to form a hydrogenated C6+ fraction, and a heavies separation system for separating the hydrogenated C6+ fraction to recover an offgas fraction, an aromatics rich naphtha fraction, and a raffinate fraction. A product recovery section is also provided for separating the C3− fraction to recover a hydrogen-containing offgas fraction, an ethylene fraction, a propylene fraction, and a light paraffin fraction.

Other aspects and advantages will be apparent from the following description and the appended claims.

### BRIEF DESCRIPTION OF DRAWINGS

The FIGURE illustrates a simplified block process flow diagram of systems according to one or more embodiments disclosed herein.

### DETAILED DESCRIPTION

Embodiments herein relate to solutions to maximize the recovery of ethylene, propylene and aromatics rich naphtha from crude oil processing. The scheme involves treating the effluent from Fluid Catalytic Cracking (FCC) to remove metals like AsH₃, PH₃, Hg, as well as impurities such as NOx and oxygen, before mixing it with the steam cracker effluent. The combined effluent is then cooled in a cold box and sent to various fractionators for separating the ethylene, propylene and aromatics rich naphtha.

As noted above, mixing FCC and steam cracker effluents poses a potential risk in cold box operation used for higher recovery of ethylene. Embodiments herein incorporate a warmer-than-typical cold box and an absorber demethanizer to mitigate these risks. These additional measures ensure not only the safe operation but also the efficient recovery of ethylene.

Another remarkable effect of embodiments herein is the flexibility in accommodating various feedstocks and adjusting product ratios. If there are changes in the quality of the feedstock, the integrated scheme can easily adapt to handle it. Similarly, if there is a need to modify the propylene to ethylene ratio, it can be readily adjusted within the system.

Addressing the NO_{X} deposition and safety issue was one of the very important tasks which was solved. Embodiments herein maximize the conversion of crude oil into valuable petrochemicals while providing enhanced flexibility in terms of feed and product processing. Additionally, embodiments herein also effectively minimize capital expenditures, maintenance costs, and plot area requirements through this unique solution. Additionally, embodiments herein prioritize safe operations. This focus on safety typically reduces the overall recovery efficiency, and to overcome the efficiency loss, additional measures have been considered within the inventive scheme.

Embodiments herein relate to processes and systems that take crude oil and/or low value heavy hydrocarbons as feed and produce petrochemicals, such as light olefins and diolefins (ethylene, propylene, butadiene, and/or butenes) and aromatics. More specifically, embodiments herein are directed toward methods and systems for making olefins and aromatics by thermal cracking and catalytic cracking, where the effluents from the thermal and catalytic cracking are co-processed for the efficient recovery of ethylene and other valuable products.

Embodiments herein are described with respect to crude oil, such as whole crude oil or a desalted whole crude oil, but any high boiling end point hydrocarbon mixture can be used. Processes disclosed herein can be applied to crudes, condensates and hydrocarbon with a wide boiling curve, including those having end points higher than 500° C. Such hydrocarbon mixtures may include whole crudes, virgin crudes, hydroprocessed crudes, gas oils, vacuum gas oils, heating oils, jet fuels, diesels, kerosenes, gasolines, synthetic naphthas, raffinate reformates, Fischer-Tropsch liquids, Fischer-Tropsch gases, natural gasolines, distillates, virgin naphthas, natural gas condensates, atmospheric pipestill bottoms, vacuum pipestill streams including bottoms, wide boiling range naphtha to gas oil condensates, heavy non-virgin hydrocarbon streams from refineries, vacuum gas oils, heavy gas oils, atmospheric residuum, hydrocracker wax, and Fischer-Tropsch wax, among others. In some embodiments, the hydrocarbon mixture may include hydrocarbons boiling from the naphtha range or lighter to the vacuum gas oil range or heavier.

One or more of the above hydrocarbon feedstocks may be fed to systems and processes herein to produce olefins and aromatics. Systems and processes herein include a separation system for separating the wide boiling hydrocarbon feedstock into a light fraction and a heavy fraction. Separation of the whole crude or other wide boiling hydrocarbon feedstock into the desired light and heavy fractions may be performed using one or more separators (distillation columns, flash drums, etc.).

In some embodiments, separation of the petroleum feeds may be performed in an integrated separation device (ISD), such as disclosed in US20130197283. In the ISD, an initial separation of a low boiling fraction is performed in the ISD based on a combination of centrifugal and cyclonic effects to separate the desired vapor fraction from liquid.

In other embodiments, separation of the petroleum feeds may be performed in a Hot Oil Processing Scheme (HOPS unit), such as described in U.S. Pat. No. 10,793,793, for example. In the HOPS unit, the hydrocarbon feedstock is preheated, mixed with dilution steam, and separated to recover a light fraction, vapor mixed with dilution steam, and a heavy fraction, a liquid stream comprising compounds that cannot be easily vaporized.

The heavy fraction is fed to a fluid catalytic cracking unit for catalytically cracking the heavy fraction to produce a catalytically cracked effluent. FCC units may include riser reactors, regenerators, and catalyst separation systems, and are well known in the art and not described further herein. The catalytically cracked effluent is fed to a fractionation system, such as a main fractionator of a FCC unit. The fractionation system is used for fractionating the catalytically cracked effluent to recover at least a wet gas fraction, a naphtha range fraction, and a heavy catalytically cracked fraction. Separation of the catalytically cracked effluent into the desired fractions may be performed using one or more separators (distillation columns, flash drums, etc.).

The wet gas fraction is then processed to separate lighter and heavier components in the wet gas and to remove various impurities before further processing. A wet gas compression system is provided for compressing and separating the wet gas fraction to form a light compressed fraction and a heavy compressed fraction. The compression system may include one or more compressors, aftercoolers, and flash drums or separates to compress the wet gas and condense heavier components therein, thereby producing a heavy compressed fraction and a light compressed fraction.

The light compressed fraction is then fed to an impurities removal system for removing impurities from the light compressed fraction and to form a purified light compressed fraction. The impurities removal system may include one or more adsorption beds, absorption systems, membrane separators, or other separation systems useful for removing contaminants such as AsH₃, PH₃, Hg, as well as impurities such as carbon dioxide, NOx and oxygen, among others, from the light compressed fraction.

The heavy compressed fraction is fed to a stripper for stabilizing the heavy compressed fraction, removing any dissolved or entrained gases within the heavier hydrocarbon fraction(s) recovered from the compression system. Stripping of the heavy compressed fraction produces a stripped heavy fraction and a stripper gas fraction. The stripper gas fraction may then be combined with the wet gas fraction for co-processing within the wet gas compression system.

A steam cracker system is provided for thermally cracking the light fraction to produce a thermally cracked effluent. If desired, the light fraction may be further separated into two or more fractions of distinct boiling ranges for processing within the steam cracker system at conditions most favorable to the hydrocarbons within the respective fractions. The steam cracker system may include one or more furnaces, each including convective coils for pre-heating the respective feeds and radiant coils for superheating the feeds to cracking temperatures.

The one or more steam cracker effluents are then quenched and separated. For example, the effluents may be collectively or individually quenched to halt the cracking reaction, quickly bringing the temperature of the effluent to below steam cracking temperatures. Quench may be performed in transfer line exchangers, direct or indirect quench against various hydrocarbon or steam streams present in the process, and other heat exchange to reduce a temperature of the steam cracker effluent to desired separation feed temperatures. Following quenching and heat recovery, the thermally cracked effluent may be fractionated to recover a light thermally cracked fraction and a fuel oil fraction.

The light thermally cracked fraction may be mixed with the purified light compressed fraction to form a combined catalytic and thermally cracked light fraction. Mixing or combining streams herein, such as the light thermally cracked fraction and the purified light compressed fraction, may be performed, for example, in a simple y- or t-type mixing device, which may or may not include static mixers. Other mixing devices known in the art may also be used for combining streams as described herein.

The combined catalytic and thermally cracked light fraction is then compressed, dried, and separated. A compression and drying system is provided for drying the combined catalytic and thermally cracked light fraction to form a dried lights fraction. The compression system may include one or more single or multi-stage compressors, as well as aftercoolers, to separate water from the steam cracked effluent and to provide a compressed combined light fraction at desired temperatures and pressures for separation of the hydrocarbons therein into desired fractions. The compression and drying system may include one or more of coalescers, adsorbents (e.g., a molecular sieve dryer), membrane separators, or absorption systems useful for separating liquid or vaporous water from the hydrocarbons.

The dried lights fraction is then fed to a lights separation system for separating the dried lights fraction to recover a C4+ hydrocarbon fraction and a C3− hydrocarbon fraction. The lights separation system may include one or more separators (distillation columns, flash drums, etc., as well as associated overheads condensation/reflux systems and reboiler systems) to provide the desired separation into the C4+ hydrocarbon fraction and a C3− hydrocarbon fraction. In some embodiments, a single distillation column is used to separate the dried lights fraction.

The C4+ hydrocarbon fraction, which may include C4, C5, C6, and heavier hydrocarbons contained in the combined catalytic and thermally cracked light fraction, is then fed to a splitter for separating the C4+ fraction into a one or more C5− fractions and a C6+ fraction. The splitter may be, for example, a distillation columns, flash drums, etc., as well as associated overheads condensation/reflux systems and reboiler systems) to provide the desired separation.

The C6+ fraction is combined with the stripped heavy fraction to form a combined C6+ fraction. The C6+ fraction may include various olefins, paraffins, and aromatics. The C6+ hydrocarbons are then processed to recover an aromatics rich naphtha fraction. The C6+ fraction may be processed, for example, in a dripolene pyrolysis gasoline unit to partially hydrogenate and separate the C6+ fraction to recover an offgas fraction, the aromatics rich naphtha fraction, and a paraffinic rich raffinate. The dripolene pyrolysis gasoline unit may include, for example, a hydrogenation system for partially hydrogenating the combined C6+ fraction to form a hydrogenated C6+ fraction, and a heavies separation system for separating the hydrogenated C6+ fraction to recover an offgas fraction, an aromatics rich naphtha fraction, and a raffinate fraction. A flow line may be provided for feeding the offgas fraction to the compression and drying system for co-processing along with the quenched thermally cracked effluent.

The C3− hydrocarbon fraction is fed to a product recovery section for separating the C3− fraction to recover a hydrogen-containing offgas fraction, an ethylene fraction, a propylene fraction, and one or more light paraffin fractions. The product recovery section may include one or more separators (distillation columns, flash drums, etc., as well as associated overheads condensation/reflux systems and reboiler systems) to provide the desired separations. In some embodiments, the system may include a demethanizer or an absorber-demethanizer, a depropanizer, a deethylenizer, and a depropylenizer, allowing for separate recovery of a methane fraction, an ethane fraction, an ethylene fraction, a propane fraction, and a propylene fraction.

The separation of the C3− hydrocarbon fraction may include one or more feed/effluent exchangers, flash drums, etc., to provide the desired separation temperatures, and in some embodiments any cold box or exchanger used is maintained at non-cryogenic temperatures to avoid the formation of N₂O₃ within the separation system. For example, in some embodiments, the absorber demethanizer and the associated overheads system and cold boxes may be operated at temperatures of greater than about −130° C., such as greater than −120° C., greater than −110° C., greater than −100° C., or greater than −90° C., thereby limiting the formation of N₂O₃. In other embodiments, the absorber demethanizer system may be operated at an overheads temperature of approximately −80° C. or greater or −70° C. or greater in yet other embodiments, such as described in U.S. Pat. No. 9,422,210, for example. Embodiments herein may thus incorporate a warmer-than-typical cold box (typical being from about −130° C. to −160° C., for example) and an absorber demethanizer to mitigate these risks. These additional measures ensure not only the safe operation but also the efficient recovery of ethylene.

The systems and processes herein may provide for continued processing of one or more of the above-noted product streams to increase process flexibility and improve the yield of ethylene, propylene, and other desired products. For example, a flow line may be provided for feeding the naphtha range fraction to the fluid catalytic cracking unit. As another manner to increase the yield of ethylene and propylene, a flow line may be provided for feeding the light paraffin fraction to the steam cracker system. As yet another means, a flow line or flow lines may be provided for feeding a portion of the one or more C5− fractions to the fluid catalytic cracking unit and/or to the steam cracker system. As further means, a flow line may be provided for feeding the raffinate fraction to the fluid catalytic cracking unit.

A simplified block process flow diagram of systems for producing olefins and aromatics according to embodiments herein is illustrated in the accompanying Figure. A wide boiling hydrocarbon feedstock 10 is fed to a separation system 12 for separating the wide boiling hydrocarbon feedstock into a heavy fraction 14 and a light fraction 16. A fluid catalytic cracking unit 20 catalytically cracks the heavy fraction 14 to produce a catalytically cracked effluent 22. A fractionation system 24 fractionates the catalytically cracked effluent 22 to recover at least a heavy catalytically cracked fraction 26, a naphtha range fraction 28, and a wet gas fraction 30. A flow line 28 may be provided for feeding the naphtha range fraction to the fluid catalytic cracking unit 20 (the flow line illustrated via connector C) to produce additional olefins.

A wet gas compression system 32 compresses and separates the wet gas fraction 30 to form a light compressed fraction 34 and a heavy compressed fraction 36. The light compressed fraction 34 is fed to an impurities removal system 38 for removing impurities from the light compressed fraction, forming a purified light compressed fraction 40. The heavy compressed fraction 36 is fed to a stripper 42 for stripping the heavy compressed fraction to recover a stripped heavy fraction 44 and a stripper gas fraction 46. A flow line or mixing system may be provided for combining the stripper gas fraction 46 with the wet gas fraction 30 upstream of the wet gas compression system 32, thereby maximizing recovery of the heavier hydrocarbons from the wet gas fraction 30.

The light fraction 16 is fed to a steam cracker system 18 for thermally cracking the light fraction to produce a thermally cracked effluent 48. A quench and separation system 50 is then used for quenching and separating the thermally cracked effluent to recover a fuel oil fraction 52 and a light thermally cracked fraction 54.

The light thermally cracked fraction 54 and the purified light compressed fraction 40 are then combined to form a combined catalytic and thermally cracked light fraction. The combined streams are then fed to compression system 56, and the resulting compressed lights stream 58 is fed to drier 60 for drying the combined catalytic and thermally cracked light fraction to form a dried lights fraction 62. Lights separation system 64 then separates the dried lights fraction 62 to recover a C4+ hydrocarbon fraction 68 and a C3− hydrocarbon fraction 66.

Splitter 80 is then used for separating the C4+ fraction 68 into one or more C5− fractions 82 and a C6+ fraction 84. The C6+ fraction 84 is then combined with the stripped heavy fraction 44 recovered from stripper 42 to form a combined C6+ fraction 94 fed to dripolene pyrolysis gas unit 96, which may include a selective hydrogenation system for partially hydrogenating the combined C6+ fraction 94 to form a hydrogenated C6+ fraction and a heavies separation system for separating the hydrogenated C6+ fraction to recover an offgas fraction 98, an aromatics rich naphtha fraction 100, and a raffinate fraction 102. The offgas fraction 92 may be fed to the compression and drying system 56, 60 for recovery of the light olefins therein (connector A). The raffinate fraction 102 may be fed to the fluid catalytic cracking unit 20 for production of additional light olefins.

The C5− fraction(s) 82 may be recovered as product streams 86. Alternatively, or additionally, a portion of the C5− fraction(s) 82 may be fed to a hydrogenation system 90, forming paraffinic or isoparaffinic C4 and C5 compounds, which may then be fed via flow line 92 to the steam cracker system 18 or optionally to the fluid catalytic cracking unit 20 (connectors B).

A light olefin product recovery section 70 is provided for separating the C3− fraction 66 to recover a hydrogen-containing offgas fraction 72, an ethylene fraction 74, a propylene fraction 76, and one or more light paraffin fractions 78. The light paraffin fraction(s) 78 may be fed via flow line 78 to the steam cracker system 18 to produce additional olefins.

As outlined above, embodiments herein may provide for conversion of crude oils and other wide boiling hydrocarbon mixtures to maximize petrochemical building blocks such as ethylene, propylene and aromatics rich naphtha. Butadiene, butene-1, benzene, toluene, and xylene can also be extracted as separate products utilizing supplemental units.

The crude oil may be processed, for example, in a Heavy Oil Processing Scheme (HOPS) available from Lummus Technology LLC. The HOPS may utilize the steam cracker furnace(s) to preheat and subsequently flash the crude to separate it at the desired cut point. The lighter portion of the crude can then be processed in the steam cracker furnace while the heavier portion is sent to the FCC unit for processing.

The effluent from the FCC reactor is sent to the main fractionator (MF) section which separates the liquid products, such as naphtha, light cycle oil (LCO), slurry oil, from the reactor effluent. The MF overhead stream may include lights hydrocarbons with carbon number ranging from C1-C9 in the form of a wet gas, which is sent to a wet gas compression section. In the wet gas compression section, the wet gas may be compressed, such as from a pressure in a range from 0.3-1 kg/cm2g to a pressure in the range from 10-16 kg/cm2g, and then separated into lighter and heavier hydrocarbons. The lighter hydrocarbons are sent for impurities removal and the heavy hydrocarbons are sent to an FCC stripper.

The FCC stripper is used to separate the light ends from the FCC stripper feed. Overhead of the FCC stripper is sent back to the wet gas compressor section and bottom of the FCC stripper which contains heavy ends are mixed with heavier HC of the steam cracker splitter and sent to the Dripoline Pyrolysis Gasoline (DPG) section. The FCC stripper can be configured to recover light hydrocarbons with carbon number ranging from C3-C6.

Light hydrocarbons from the wet gas compression section and the FCC stripper are combined and treated for the removal of the oxygenates, acid gases and any other impurities and then mixed with stream cracker effluent. The combined effluent from steam cracker and FCC is dried and sent to the lights ends separator, which separates the C1-C3s from heavier hydrocarbons and C1-C3s are sent to the product recovery section.

The product recovery section is used to separate the ethylene, propylene and hydrogen/off gas from ethane and propane. Ethylene and propylene are withdrawn as a product and ethane/propane are recycled back to the steam cracker. Offgas can be utilized as a fuel to the steam cracker furnace(s) and/or can be used as a regeneration media of the various treaters or can be sent as a product. Hydrogen recovered may be used in the various hydrogenation reactors available in the scheme.

Heavier hydrocarbons from the lights ends separator are sent to the splitter which can separate C4/C5 from the heavier hydrocarbons. C4/C5 are sent to the C4/C5 hydrogenation section which hydrogenates them as per process needs and are recycled back to the FCC unit or steam cracker furnace(s). Heavier hydrocarbons (C6+) from the splitter are mixed with FCC stripper bottoms and sent to the Dripoline Pyrolysis Gasoline (DPG) section which hydrogenates the olefinic hydrocarbons. Aromatics rich naphtha is withdrawn from the DPG unit and can be sent to an aromatics extraction unit for the recovery of benzene, toluene and xylenes, or it can be blended with the gasoline pool. Raffinate from the DPG unit is recycled back to the FCC or steam cracker for additional olefins production.

Embodiments and flow schemes described herein provide a solution to refiners who are looking for maximizing petrochemicals such as ethylene & propylene directly from crude. The Total Investment Cost (TIC) is significantly reduced in embodiments herein due to the utilization of fewer equipment (less piece count) compared to traditional crude processing. The reduced equipment count not only contributes to lower investment costs but also leads to a smaller plot size area requirement, optimizing the efficient use of space. Embodiments herein are also flexible for feed variation and change in product demand (propylene/ethylene). As a result, embodiments herein may maximize the profit margin per ton of feed charge, enhancing the financial returns for refiners.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the word “approximately” or “about” are used, this term may mean that there can be a variance in value of up to +10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed as new and desired to be protected by Letters Patent is:

1. A process for producing olefins and aromatics from wide boiling hydrocarbon feedstock, the process comprising:
separating the wide boiling hydrocarbon feedstock into a light fraction and a heavy fraction;
catalytically cracking the heavy fraction to produce a catalytically cracked effluent;
fractionating the catalytically cracked effluent to recover at least a wet gas fraction, a naphtha range fraction, and a heavy catalytically cracked fraction;
compressing and separating the wet gas fraction to form a light compressed fraction and a heavy compressed fraction;
removing impurities from the light compressed fraction to form a purified light compressed fraction;
stripping the heavy compressed fraction to recover a stripped heavy fraction and a stripper gas fraction;
combining the stripper gas fraction with the wet gas fraction prior to the compressing and separating the wet gas fraction;
thermally cracking the light fraction to produce a thermally cracked effluent;
quenching and separating the thermally cracked effluent to recover a fuel oil fraction and a light thermally cracked fraction;
combining the light thermally cracked fraction with the purified light compressed fraction to form a combined catalytic and thermally cracked light fraction;
drying the combined catalytic and thermally cracked light fraction to form a dried lights fraction;
separating the dried lights fraction to recover a C4+ hydrocarbon fraction and a C3− hydrocarbon fraction;
splitting the C4+ hydrocarbon fraction into a one or more C5− hydrocarbon fractions and a C6+ hydrocarbon fraction;
mixing the C6+ hydrocarbon fraction with the stripped heavy fraction to form a combined C6+ hydrocarbon fraction;
partially hydrogenating the combined C6+ hydrocarbon fraction to form a hydrogenated C6+ hydrocarbon fraction;
separating the hydrogenated C6+ hydrocarbon fraction to recover an offgas fraction, an aromatics rich naphtha fraction, and a raffinate fraction; and
separating the C3− hydrocarbon fraction to recover an hydrogen-containing offgas fraction, an ethylene fraction, a propylene fraction, and a light paraffin fraction.

2. The process as claimed in claim 1, further comprising feeding the naphtha range fraction to the catalytically cracking the heavy fraction.

3. The process as claimed in claim 1, further comprising feeding the light paraffin fraction to the thermally cracking the light fraction.

4. The process as claimed in claim 1, further comprising hydrogenating a portion of the one or more C5− hydrocarbon fractions to produce a hydrogenated C5− hydrocarbon fraction and feeding the hydrogenated C5− hydrocarbon fraction to the catalytically cracking the heavy fraction.

5. The process as claimed in claim 1, further comprising hydrogenating a portion of the one or more C5− hydrocarbon fractions to produce a hydrogenated C5− hydrocarbon fraction and feeding the hydrogenated C5− hydrocarbon fraction to the thermally cracking the light fraction.

6. The process as claimed in claim 1, further comprising feeding the raffinate fraction to the catalytically cracking the heavy fraction.

7. The process as claimed in claim 1, further comprising feeding the offgas fraction to the compressing and separating the wet gas fraction.

8. A system for producing olefins and aromatics from a wide boiling hydrocarbon feedstock, the system comprising:
a separation system for separating the wide boiling hydrocarbon feedstock into a light fraction and a heavy fraction;
a fluid catalytic cracking unit for catalytically cracking the heavy fraction to produce a catalytically cracked effluent;
a fractionation system for fractionating the catalytically cracked effluent to recover at least a wet gas fraction, a naphtha range fraction, and a heavy catalytically cracked fraction;
a wet gas compression system for compressing and separating the wet gas fraction to form a light compressed fraction and a heavy compressed fraction;
an impurities removal system for removing impurities from the light compressed fraction to form a purified light compressed fraction;
a stripper for stripping the heavy compressed fraction to recover a stripped heavy fraction and a stripper gas fraction;
a flow line for combining the stripper gas fraction with the wet gas fraction upstream of the wet gas compression system;
a steam cracker system for thermally cracking the light fraction to produce a thermally cracked effluent;
a quench and separation system for quenching and separating the thermally cracked effluent to recover a fuel oil fraction and a light thermally cracked fraction;
a mixer for combining the light thermally cracked fraction with the purified light compressed fraction to form a combined catalytic and thermally cracked light fraction;
a compression and drying system for drying the combined catalytic and thermally cracked light fraction to form a dried lights fraction;
a lights separation system for separating the dried lights fraction to recover a C4+ hydrocarbon fraction and a C3− hydrocarbon fraction;
a splitter for splitting the C4+ hydrocarbon fraction into one or more C5− hydrocarbon fractions and a C6+ hydrocarbon fraction;
a mixer for mixing the C6+ hydrocarbon fraction with the stripped heavy fraction to form a combined C6+ hydrocarbon fraction;
a hydrogenation system for partially hydrogenating the combined C6+ hydrocarbon fraction to form a hydrogenated C6+ hydrocarbon fraction;
a heavies separation system for separating the hydrogenated C6+ hydrocarbon fraction to recover an offgas fraction, an aromatics rich naphtha fraction, and a raffinate fraction; and
a product recovery section for separating the C3− hydrocarbon fraction to recover a hydrogen-containing offgas fraction, an ethylene fraction, a propylene fraction, and a light paraffin fraction.

9. The system as claimed in claim 8, further comprising a flow line for feeding the naphtha range fraction to the fluid catalytic cracking unit.

10. The system as claimed in claim 8, further comprising a flow line for feeding the light paraffin fraction to the steam cracker system.

11. The system as claimed in claim 8, further comprising a flow line for feeding a portion of the one or more C5− hydrocarbon fractions to the fluid catalytic cracking unit.

12. The system as claimed in claim 11, further comprising a hydrogenation system for hydrogenating the portion of the one or more C5− hydrocarbon fractions to produce a hydrogenated C5− hydrocarbon fraction fed to the fluid catalytic cracking unit.

13. The system as claimed in claim 8, further comprising a flow line for feeding a portion of the one or more C5− hydrocarbon fractions to the steam cracker system.

14. The system as claimed in claim 13, further comprising a hydrogenation system for hydrogenating the portion of the one or more C5− hydrocarbon fractions to produce a hydrogenated C5− hydrocarbon fraction fed to the steam cracker system.

15. The system as claimed in claim 8, further comprising feeding the raffinate fraction to the fluid catalytic cracking unit.

16. The system as claimed in claim 8, further comprising a flow line for feeding the offgas fraction to the compression and drying system.
